(19) United States
(12) Patent Application Publication
(10) Pub. No.: US 2011/0006254 A1
(43) Pub. Date: Jan. 13, 2011

(54) PROCESS TO MAKE ELECTROCHEMICALLY ACTIVE/INACTIVE NANOCOMPOSITE MATERIAL

(75) Inventors: Monique N. Richard, Ann Arbor, MI (US); Claudia Luhrs, Rio Rancho, NM (US); Jonathan Phillips, Rio Rancho, NM (US)

Correspondence Address: GIFFORD, KRASS, SPRINKLE,;ANDERSON & CITKOWSKI, P.C., P.O. BOX 7021, TROY, MI, 48007-7021, US

(73) Assignees: Toyota Motor Engineering & Manufacturing North America, Inc., Erlanger, KY (US); Regents of the University of New Mexico, Albuquerque, NM (US); Los Alamos National Security, LLC, Los Alamos, NM (US)

(21) Appl. No.: 12/498,410

(22) Filed: Jul. 7, 2009

(51) Int. Cl. H01M 4/88

(52) U.S. Cl. 252/182.1

(57) ABSTRACT

A process for making an first material/second material nanocomposite is disclosed. The process can include providing a precursor that contains an electrochemically active and an electrochemically inactive material. Thereafter, the precursor can be suspended in an aerosol gas to produce an aerosol and a plasma having a high field zone can be provided. The aerosol can be passed through the high field zone of the plasma and result in the vaporization of at least part of the precursor in the aerosol. The precursor that has been vaporized in the high field zone is subsequently removed therefrom and allowed to condense into an first material/second material nanocomposite with at least one electrochemically active material.

### GOVERNMENT INTEREST

This invention was made with government support under Contract No. DE-AC52-06NA25396 awarded by the U.S. Department of Energy. The Government has certain rights in the invention.

### FIELD OF THE INVENTION

The present invention relates to a process to make a nanocomposite material, and in particular nanocomposite that contains at least one electrochemically active component.

### BACKGROUND OF THE INVENTION

The development and production of nanoparticles has been the focus of research efforts for at least the last ten years with the properties of nanoparticles often exhibiting behavior that bridges the gap between bulk materials and atomic or molecular structures. For example, nanoparticles can exhibit properties that are dependent on the size of particles and properties such as melting temperatures, thermal and/or electrical conductivity, physical hardness and the like can be vastly different when compared to bulk materials having the same chemical composition.

Nanocomposite materials that contain a mixture of a first material and a second material would also be useful in providing composite structures for use with catalytic processes, electrochemical processes and the like. However, heretofore processes for making nanocomposite materials have been limited with respect to the uniformity of the first material and/or the second material and production rates.

Processes used to produce metal nanoparticles and/or nanocomposites can include gas evaporation, mechanical attrition, sputtering, pyrolysis of organometallic compounds, microwave plasma decomposition of organometallic compounds and the like. Plasma decomposition of dry precursor powders has proven to be an effective method for producing nanoparticles since dry precursor powders can simplify material handling concerns and a relatively tight range of particle size can be obtained. However, previous processes using plasma decomposition has typically resulted in core-shell nanoparticles. As such, a process for making a nanocomposite that has a mixture of a first material and a second material with a relatively tight range of particle size for the first material and/or the second material would be desirable.

### SUMMARY OF THE INVENTION

A process for making a nanocomposite that contains at least one electrochemically active component is disclosed. The process can include providing a precursor that contains an electrochemically active and an electrochemically inactive material or a precursor that contains electrochemically active materials. Thereafter, the precursor can be suspended in an aerosol gas to produce an aerosol. A plasma can be provided and the aerosol can be passed through the high field zone of the plasma with the vaporization of at least part of precursor The precursor vaporized in the high field zone can be removed from the high field zone and allowed to condense into an electrochemically active/inactive nanocomposite or into a nanocomposite composite composed of 2 electrochemically active components. In either case, the nanocomposite material can have an average grain size of less than 100 nanometers and in some instances has an average grain size of less 50 nanometers or less than 25 nanometers.

The precursor can be in the form of a powder, a liquid and/or a vapor of a liquid. The electrochemically active material can be a material capable of intercalation of lithium or a lithium alloying material and may or may not contain elements such as carbon, tin, silicon, aluminum, germanium and combinations thereof. In some instances, the electrochemically active material is a pre-lithiated material. The electrochemically inactive material can contain an element such as carbon, nitrogen and/or oxygen and it may also contain the elements capable of alloying with lithium, only in an electrochemically inactive phase.

The aerosol gas can be an inert gas, for example argon. In addition, the aerosol can pass through a tube that terminates within the high field zone of the plasma and a plasma gas that passes through the high field zone may also be included. The plasma can be a non-oxidizing plasma and in some instances is a low power atmospheric or near-atmospheric pressure plasma with microwave energy focused within a coupler.

### BRIEF DESCRIPTION OF THE DRAWINGS

FIG. 1 is a schematic diagram illustrating a process for producing the nanocomposite material;

FIG. 2A is a schematic representation of a nanocomposite material made according to an embodiment of the present invention;

FIG. 2B is a schematic representation of a nanocomposite material made according to another embodiment of the present invention;

FIG. 2C is a schematic representation of a nanocomposite material made from yet another embodiment of the present invention;

FIG. 3 is a schematic representation of an apparatus used to make an nanocomposite material;

FIG. 4 is a scanning electron microscopy image of an electrochemically active nanocomposite material made according to an embodiment of the present invention; and

FIG. 5 is a transmission electron microscopy image of an electrochemically active/inactive nanocomposite material made according to an embodiment of the present invention.

### DETAILED DESCRIPTION OF THE INVENTION

The present invention discloses a process for making a nanocomposite material having at least one electrochemically active material. The nanocomposite material can be used as an electroactive material. As such, the present invention has utility as a process for making a material.

The process includes providing a precursor that contains the elements for a first material/second material composite. In some instances, a first material precursor can contain an element, and/or an element of a compound, that is an electrochemically active material and a second material precursor can contain an element, and/or an element of a compound, that is an electrochemically inactive material, or vice versa. After the precursor is provided, it can be suspended in an aerosol gas to produce an aerosol. A plasma having a high field zone can also be provided, and the aerosol can be passed through the high field zone of the plasma.

At least part of the first material precursor and at least part of the second material precursor in the aerosol can be vaporized and subsequently removed from the high field zone of the plasma. Thereafter, the vaporized materials are allowed to condense into a first material/second material nanocomposite. In some instances, at least part of the vaporized material can condense into an active/inactive nanocomposite. In other instances, at least part of the vaporized material can condense into an active/active nanocomposite.

The nanocomposite can have the structure of the first material or the second material being in the form of nanoparticles and the second material or the first material, respectively, being in the form of a supporting matrix for the nanoparticles. In the alternative, the second material or the first material, respectively, can also be in the form of nanoparticles, thereby resulting in a nanocomposite made of first material nanoparticles and second material nanoparticles, or vice versa. It is appreciated that neither first material nor the second material in the nanocomposite fully encapsulates the other material. Stated differently. some of the first material and/or the second material may be encapsulated due to the random structure of the composite, however the structure is not inherently a structure in which one material encapsulates the other, such as, for example core-shell particles.

For the purposes of the present invention, the term “supporting matrix” is defined as a matrix that holds or supports nanoparticles such that the nanoparticles can be in physical contact with a surrounding gas and/or liquid. It is appreciated that this definition includes a structure that supports one or more nanoparticles within the matrix that do not have physical contact with a surrounding gas and/or liquid, so long as one or more nanoparticles do have physical contact with the surrounding gas and/or liquid. It is further appreciated that this definition does not include core-shell structured nanoparticles as disclosed in co-assigned U.S. patent application Ser. No. 11/956,936 filed on Dec. 14, 2007 and which is incorporated herein in its entirety by reference. It is still further appreciated, that for the purposes of the present invention, a ‘nano’ material is one in which at least one of its dimensions (i.e. length, width or breadth) has a dimension less than 500 nm.

The precursor can be in the form of a powder, a liquid and/or a vapor of a liquid. The first material precursor can contain an element and/or an element of a compound that is electrochemically active. In some instances, the electrochemically active material can contain carbon, tin, silicon, aluminum, germanium and alloys thereof. The electrochemically active material can also be a pre-lithiated material made from an electrochemically active material alloyed with lithium before being provided as at least part of the precursor.

The second material precursor can contain elements that are electrochemically active or inactive, such as carbon, nitrogen, oxygen, and combinations thereof. For example, the electrochemically inactive material can be a compound containing an element capable of alloying with lithium but in an inactive form, a carbide, a nitride, an oxide and the like. In some instances, the first material/second material nanocomposite can be in the form of a porous or nonporous matrix of the second material with nanoparticles of the first material attached to a surface of the second material matrix and/or incorporated within the matrix. In other instances, the first material/second material nanocomposite can be in the form of a mixture of nanoparticles containing the first material and nanoparticles containing the second material.

The aerosol gas can be an inert gas, for example argon, helium, argon, nitrogen and the like. The aerosol can pass through a tube that terminates within the high field zone of the plasma and a plasma gas can further be provided that also passes through the high field zone of the plasma. The plasma can be a non-oxidizing plasma and may or may not be a low power atmospheric or near atmospheric pressure plasma where microwave energy is focused within a coupler. In the alternative, the plasma can be oxidizing plasma with oxygen included in the aerosol gas and/or a plasma gas used to generate the plasma. In addition, a plasma having a high field zone can also be generated using microwave, RF, corona discharge, DC field, or other energy sources.

The first material/second material nanocomposite can have an average grain size of less than 100 nanometers (nm) and may include exposing the first material/second material nanocomposite to a treatment that alloys the first material with lithium. In some instances, the average grain size of the nanocomposite is less than 50 nm, while in other instances the average grain size is less than 25 nm. In addition, nanoparticles of the first material and/or second material can have an average mean diameter of less 100 nm, less than 50 nm or less than 25 nm.

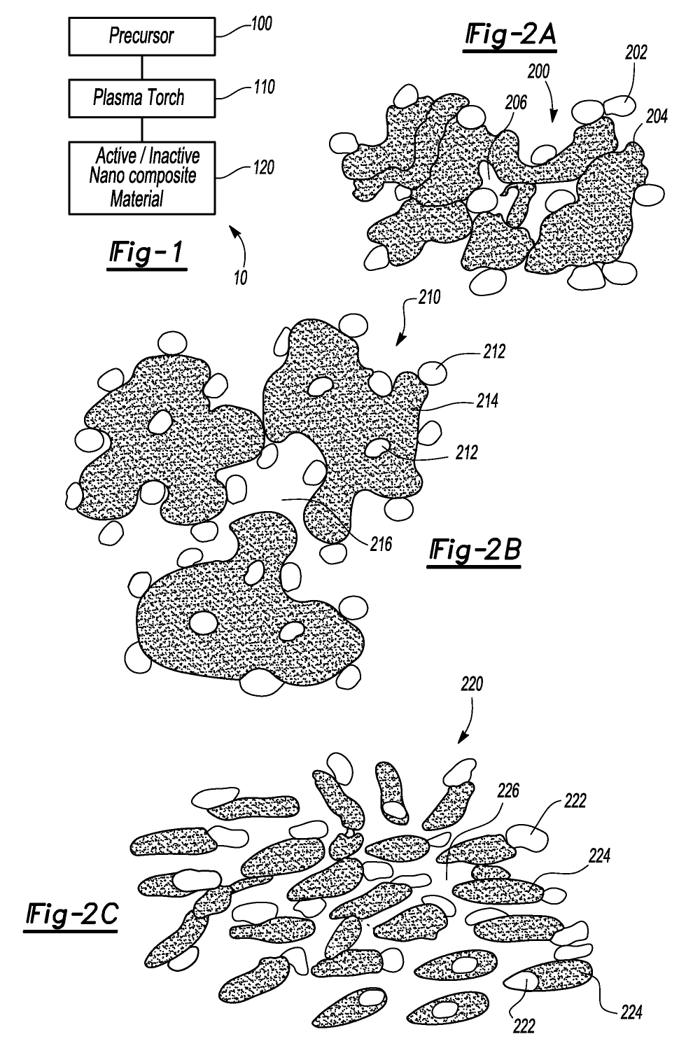

Turning now to FIG. 1, an embodiment for producing a nanocomposite material is shown generally at reference numeral 10. The process 10 includes providing a precursor in the form of a powder, a liquid and/or a vapor of a liquid at step 100 and passing the precursor through a plasma torch at step 110. Upon passing the precursor through the plasma torch at step 110, at least part of the precursor is vaporized. The vaporized materials flows out of the high field zone and is allowed to condense to form the nanocomposite material at step 120.

Schematic representations of nanocomposite materials are shown in FIGS. 2A-2C. In particular, FIG. 2A illustrates a nanocomposite material at reference numeral 200 with the first materials nanoparticles 202 mixed and in contact with the second material 204. In some instances, porosity 206 can be present within the nanocomposite 200. It is appreciated that the size differences between the first material nanoparticles 202 and the second material 204 is for example purposes only. As such, the second material 204 could be of generally the same mean size as the first material 202, be generally twice as large as the first material and the like. In such an instance, it is appreciated that the nanocomposite 200 can be a mixture of first material nanoparticles and second material nanoparticles.

With reference to FIG. 2B, a first material/second material nanocomposite material 210 similar to the first material/second material nanocomposite 200 is shown. However, the material 210 has nanoparticles 212 made from the first material 1 also incorporated within the second material 214. In addition, porosity, pores, void space 216 and the like between particles of the first material/second material nanocomposite material can be present. As stated above, the size disparity between the first material nanoparticles 212 and second material particles 214 is for example purposes only.

FIG. 2C illustrates an first material/second materials nanocomposite material 220 having elongated structures made from first material nanoparticles 222 attached to the surface of or incorporated within a second material 224, or simply mixed together. In addition, void space 226 can be present between the rod-shaped nanoparticles. It is appreciated that the diagrams shown in FIGS. 2A-2C are for illustrative purposes only and are discussed in order to teach that a variety of first material/second material nanocomposite structures can be made with the process disclosed herein.

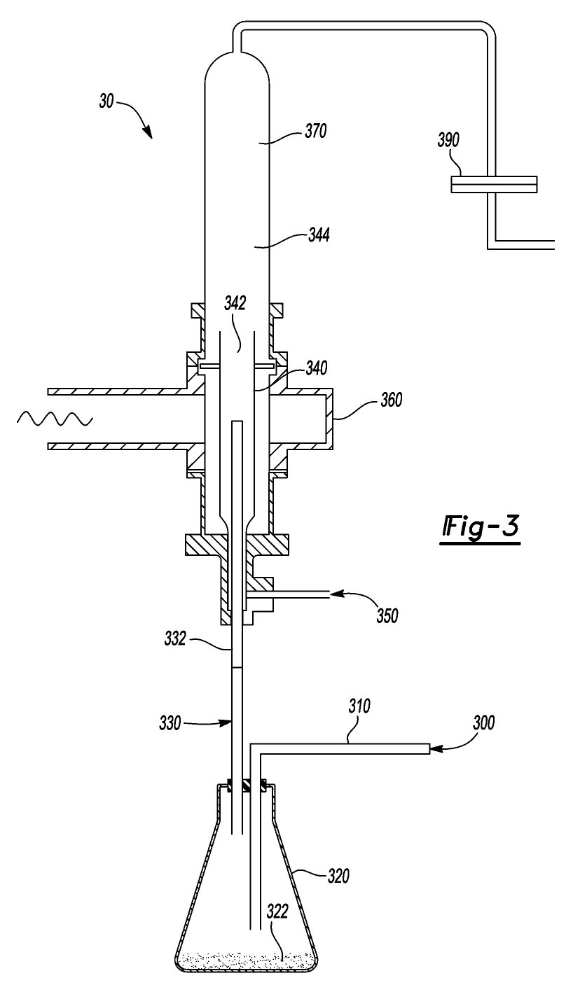

Turning now to FIG. 3, a schematic representation of an apparatus for producing a nanocomposites is shown generally at reference numeral 30. As shown in this figure, an aerosol gas 300 passes through an inlet tube 310 into a precursor container 320 that contains a precursor 322. Flow of the aerosol gas 300 into the precursor container 320 at a sufficient flow rate results in the suspension of the precursor 322 within the aerosol gas 300 to produce an aerosol. The precursor 322 can contain a first material precursor and a second material precursor. The precursor 322 can also contain elements that are not incorporated within the first material/second material nanocomposite that is produced, but may be present to assist in the overall process in some manner. In some instances, the first material precursor contains an electrochemically active material and the second material precursor contains an electrochemically inactive material.

After the aerosol has been produced, it can pass or flow through the exit tube 330 with at least part of the exit tube 330 passing into a quartz plasma torch 340. In some instances, the exit tube 330 has a ceramic portion 332 that terminates generally in the middle of a waveguide 360. The waveguide 360 is used to couple microwave energy to the plasma torch 340. Also included can be a plasma gas 350 which passes within the plasma torch 340, but exterior to the ceramic portion 332 of the exit tube 330 which has the aerosol passing therethrough. Upon focusing microwave energy with the waveguide 360 onto the plasma torch 340, a plasma can be generated with a high field zone 342 located within the plasma torch 340. As the aerosol with the precursor 322 passes through the high field zone 342 of the plasma torch 340, the temperature of the high field zone 342 is such that at least part of the precursor 322 is vaporized. The vaporized precursor 322 exits the high field zone 342 of the plasma torch 340 and enters into a chimney region 370. Upon exiting the high field zone 342, the atoms of the vaporized precursor condense into solid particles.

If the precursor 322 contains the first material and the second material, the passing or flowing of the aerosol through the high field zone 342 of the plasma torch 340 results in the vaporization of at least part of the first material and at least part of the second material. Thereafter, the first and second material atoms condense into a first material/second material nanocomposite. The first material/second material nanocomposite can be collected from a particle filter 390, from the interior sidewalls of the chimney region 370 and/or from a particle trap (not shown).

Not being bound by theory, the mechanism for the formation of the first material/second material nanocomposite is hypothesized to result from the condensation of first material atoms and second material atoms to form particles via a nucleation process. The condensed first material atoms and second material atoms collect on similar nuclei, however based on relative miscibility between the two materials, the second material atoms are rejected from the first material, or vice versa, and thereby form a first material/second material nanocomposite. It is appreciated that the rejection of the second material atoms may or may not occur until cooling has occurred and/or the material has reached an afterglow region 344. After leaving the high field region the first material/second material nanocomposite enters the afterglow region 344 of the apparatus in which no further growth occurs. Therefore, in the afterglow region the first material/second material nanocomposite is “frozen” into its final configuration.

As illustrated in FIGS. 2A-2C, a range of nanocomposite structures can be provided. In addition, the amount and/or size of the first and/or second material in the nanocomposite can be adjusted by altering the amount of the first and/or second material in the precursor, the aerosol gas, the aerosol gas flow rate, the plasma gas, the plasma gas flow rate, the microwave power and the like.

In order to better illustrate an embodiment of the present invention, two examples of a process wherein first material/second material nanocomposites were produced are provided below.

### EXAMPLE 1

With reference to FIG. 4, a nanoparticulate mixture of tin and carbon was produced with tin nanoparticles dispersed within a carbon matrix. The precursor contained micron-sized particles of tin that melted and vaporized within the plasma torch environment and anthracene as a carbon source. The anthracene decomposed and resulted in carbon as a solid byproduct, however other carbon sources can be used as well. The conditions for producing the tin-carbon nanocomposite material included an argon plasma gas having a flow rate of 3.5 standard liters per minute (slpm), an aerosol argon carrier gas having a flow rate of 1.4 slpm and 900 watts of microwave power. The pressure in the exhaust of the plasma was 20 torr below atmospheric pressure.

As shown in FIG. 4, an intimate mixture of tin nanoparticles with a carbon support matrix is provided. It is appreciated that such a structure can be used as a battery material.

### EXAMPLE 2

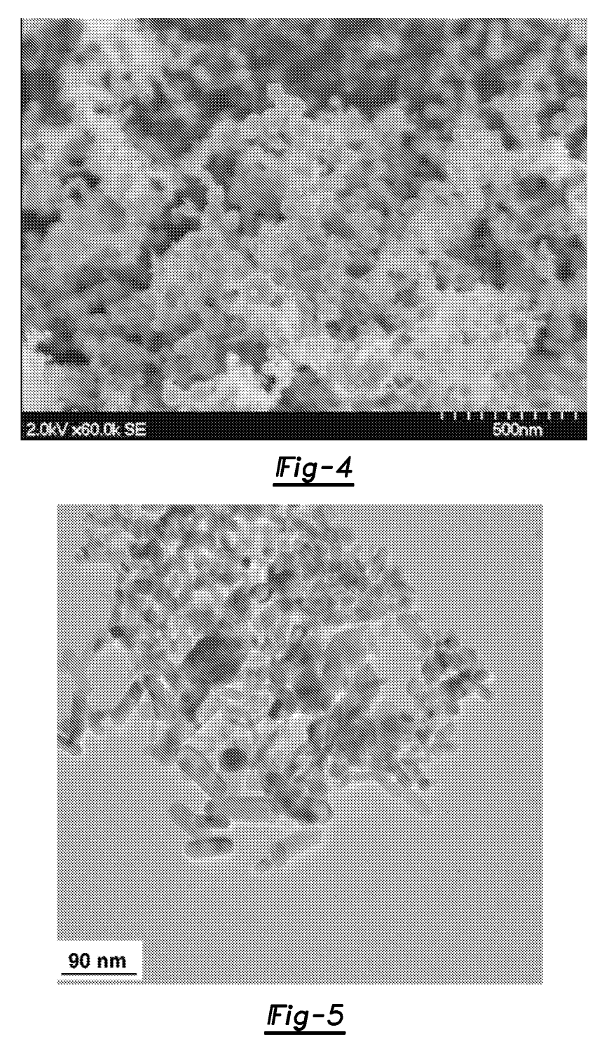

With reference to FIG. 5, a nanocomposite material having nanoparticles of tantalum oxide (TaO₂) and tin oxide (SnO₂) was produced using a precursor containing tin and tantalum. It is appreciated that the precursor can contain the first material and the second material in the form of a compound, e.g. a salt, oxide, nitride, chloride, etc of the first and/or second material. In this example, the precursor was made from Sn and Ta powders with the precursor powder incorporated within an aerosol gas of argon at a flow rate of 1.1 slpm along with 0.4 slpm of oxygen. The plasma gas was also argon having a flow rate of 3.5 slpm. The plasma torch had 900 watts of microwave power and the pressure in the exhaust of the plasma torch was close to atmospheric.

Upon exiting the high field region of the plasma torch, a nanocomposite of rod shaped nanoparticles of active metal oxide with nanoparticles of inactive metal oxide mixed therewith was produced.

In this manner, a first material/second material nanocomposite can be provided where in some instances the first material is an electrochemically active material and the second material is an electrochemically inactive material. Such a nanocomposite material has a relatively uniform distribution of particle size, grain size and the like of the first material and/or the second material and a thorough mixture of the two materials is also provided.

It is appreciated that the present invention is not bound by or to specific flow string rates, compositions or configurations. In addition, even though the above examples disclose a process having a dual gas flow system with each gas flow having a different overall composition that join and mix only at the plasma high field zone, other gas flow and/or plasma systems are included within the scope of the present invention. For example and for illustrative purposes only, a process using a direct current discharge plasma having a one flow gas system wherein an aerosol gas and a plasma gas are one in the same is within the scope of the disclosed inventive process. This process would result in all of the gas that flows through the plasma and the precursor being well mixed before reaching the high field zone as opposed to the two gas flow system wherein the aerosol gas and the plasma gas mix with each other in the center of the high field zone as described in the examples above.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

We claim:

1. A process for making a first material/second material nanocomposite with at least one electrochemically active component, the process including:
providing a precursor containing a first material and a second material;
suspending the precursor in an aerosol gas to produce an aerosol;
providing a plasma having a high field zone;
passing the aerosol through the high field zone of the plasma;
vaporizing at least part of the first and second material precursors in the aerosol;
removing the vaporized precursor from the high field zone of the plasma; and
allowing the vaporized precursor to condense into an first material/second material nanocomposite, wherein both the first and second materials are nanoparticulate.

2. The process of claim 1, wherein the first material is an electrochemically active material and the second material is an electrochemically inactive material.

3. The process of claim 1, wherein the first material and the second material are both an electrochemically active material.

4. The process of claim 1, wherein the precursor is selected from the group consisting of a powder, a liquid, a vapor of a liquid and combinations thereof.

5. The process of claim 1, wherein the electrochemically active material is a lithium alloying material.

6. The process of claim 5, wherein the electrochemically active material contains an element selected from the group consisting of carbon, tin, silicon, aluminum, germanium and combinations thereof.

7. The process of claim 5, wherein the electrochemically active material is a pre-lithiated material.

8. The process of claim 1, wherein the electrochemically inactive material contains an element selected from the group consisting of carbon, nitrogen and oxygen.

9. The process of claim 1, wherein the aerosol gas is an inert gas.

10. The process of claim 1, wherein the aerosol gas is an inert gas containing oxygen.

11. The process of claim 10, wherein the aerosol gas is argon containing oxygen.

12. The process of claim 9, wherein the inert gas is selected from the group consisting of argon and nitrogen.

13. The process of claim 1, wherein the aerosol containing the precursor and carrier gas is directed to high field zone of the plasma.

14. The process of claim 1, further including supplying a plasma gas that by the interaction with the microwave guide generates a high field zone of the plasma.

15. The process of claim 1, wherein the plasma is an oxidizing plasma.

16. The process of claim 1, wherein the plasma is an inert plasma.

17. The process of claim 1, wherein the plasma is a low power atmospheric or near atmospheric pressure plasma with microwave energy focused within a coupler.

18. The process of claim 1, wherein the first material/second material nanocomposite has an average grain size of less than 100 nanometers.

19. A process for making a first material/second material nanocomposite material, the process including:
providing a precursor containing a first material and a second material;
suspending the precursor in an aerosol gas to produce an aerosol;
providing a plasma torch;
providing an aerosol tube that terminates within the plasma torch;
providing a plasma gas that passes through the plasma torch exterior to the aerosol tube;
generating a plasma using the plasma gas, the plasma having a high field zone;
passing the aerosol through the aerosol tube, the aerosol exiting the aerosol tube and entering into the high field zone of the plasma;
vaporizing at least part of the precursor material in the aerosol in the high field zone of the plasma;
passing the precursor materials that has been vaporized through the high field zone of the plasma into an afterglow region; and
allowing the precursor that has been vaporized to condense into a first material/second material nanocomposite.

20. The process of claim 19, wherein the first material is an electrochemically active material and the second material is an electrochemically inactive material.

21. The process of claim 19, wherein the first material and the second material are both an electrochemically active material.

22. The process of claim 19, wherein the precursor is selected from the group consisting of a powder, a liquid, a vapor of a liquid and combinations thereof.

23. The process of claim 19, wherein the electrochemically active material is a lithium alloying material.

24. The process of claim 23, wherein the electrochemically active material contains an element selected from the group consisting of carbon, tin, silicon, aluminum, germanium and combinations thereof.

25. The process of claim 23, wherein the electrochemically active material is a pre-lithiated material.

26. The process of claim 19, wherein the second material is tantalum oxide.

27. A process for making a first material/second material nanocomposite with at least one electrochemically active component, the process comprising:
providing a precursor for a first material;
providing a precursor for a second material;
suspending each precursor in separate aerosol streams;
providing a plasma having a high field zone;
combining the aerosol streams before or in the high field hot zone;
passing the combined aerosol streams through the high field zone of the plasma;
vaporizing at least part of the first and second material precursors in the combined aerosol streams;
removing vaporized precursor from the high field zone of the plasma; and
allowing the vaporized precursor to condense into an first material/second material nanocomposite, wherein both the first and second materials are nanoparticulate.

28. The process of claim 27, wherein the aerosol stream for the first material is an inert gas with the precursor for the first material suspended therein.

29. The process of claim 27, wherein the aerosol stream for the first material is an inert gas containing oxygen with the precursor for the first material suspended therein.

30. The process of claim 27, wherein the aerosol stream for the second material is an inert gas with the precursor for the second material is suspended therein.

31. The process of claim 27, wherein the aerosol stream for the second material is an inert gas containing oxygen with the precursor for the second material suspended therein.
